(19) United States
(12) Patent Application Publication
(10) Pub. No.: US 2007/0019578 A1
(43) Pub. Date: Jan. 25, 2007

(54) Method for efficient energy consumption in battery powered handheld and mobile devices

(75) Inventor: Dror Meiri, Haifa (IL)

Correspondence Address: TIAJOLOFF & KELLY, CHRYSLER BUILDING, 37TH FL, 405 LEXINGTON AVE, NEW YORK, NY, 10174, US

(73) Assignee: Siano Mobile Silicon Ltd., Netanya (IL)

(21) Appl. No.: 11/486,365

(22) Filed: Jul. 13, 2006

Related U.S. Application Data
(60) Provisional application No. 60/698,944, filed on Jul. 14, 2005.

(51) Int. Cl. G08C 17/00

(52) U.S. Cl. 370/311

(57) ABSTRACT

A method of mitigating power consumption in a DVB-H receiver is provided. The method may include predicting reception error(s) associated with a data burst to be received by the receiver, and deciding, based on the prediction result, to process or to eschew processing of MPE-FEC redundancy section(s) associated with the data burst, prior to the reception of the data burst. Predicting may include evaluating reception quality before receiving the data burst, by using data provided by the receiver's demodulator, wherein evaluating may be based on calculating a reception function (F) at the receiver, by using measured or calculated, scaled or weighted, parameter(s) associated with data received prior to the reception of the data burst. MPE-FEC redundancy section(s) associated with a received data burst may be processed only if the value of the reception function F is greater than a predetermined threshold value. Predicting may be based on data provided by the receiver's MPE-FEC unit. The scaling/weighting factors may be adjusted according to a policy to optimize reception conditions. Prediction may be enhanced by considering reception history, by utilizing reception function. A receiver is also provided, which utilizes the method.

### FIELD OF THE DISCLOSURE

The present disclosure relates generally to the field of television broadcasting. More specifically, the present disclosure relates to a method for saving power in battery powered handheld and mobile devices while receiving multimedia information/data, including television (“TV”) broadcasts.

### BACKGROUND

The capacity of multimedia services rendered is growing rapidly, side by side with communication standards that are being continuously formulated to adapt services to handheld, and in general to mobile wireless services rendering devices.

One aspect of the rapid growth of multimedia services capacity is that many handheld digital telecommunication and/or multimedia systems are designed for multitask applications, such as audio, video and graphics capabilities, television reception and modem capabilities. Exemplary systems/devices are cellular phones, palm-PCs, portable media players, digital video cameras and digital still cameras.

In addition, the deployment of mobile devices with integrated support for the reception of digital TV signals is now a reality. Until now, the feasibility of such support has been limited by several key factors such as power consumption, performance and size. Most attempts at addressing the handheld receiver market have been based on adapting existing home set-top box solutions to the demanding environment of mobile reception.

Currently, there are devices capable of receiving TV broadcasts that conform to mobile digital video broadcast terrestrial (“DVB-T”) standards. Despite the success of mobile DVB-T reception, the major concern with any handheld device is that of battery life. However, when DVB-T was first published in 1997, it wasn't originally designed for mobile receivers. The current and projected power consumption of DVB-T front ends is too high to support handheld receivers that expect to last from one to several days on a single charge. In addition, mobile DVB-T receivers utilize antenna diversity technology that increases both power consumption and size.

The DVB-H (‘H’ standing for ‘handheld’) standard, which is actually an adaptation of the mobile DVB-T standard to handheld devices, utilizes also ‘time-slicing’ to reduce receiver power consumption, and multiprotocol encapsulation forward error correction (“MPE-FEC”) to provide an additional layer of error correction.

Time slicing generally involves sending data in bursts using a significantly higher bit rate compared to the bit rate required if the data were transmitted continuously. An avowed goal of ‘time-slicing’ is to reduce the average power consumption of the involved terminal, and enable smooth and seamless service handover. Using time slicing allows inactivating (shutting-down or disabling) the receiver for a considerable amount of time. The result, in some cases, is a power saving of about 90%. Each burst of data creates a data structure called MPE-FEC frame. The structure and processing of an MPE-FEC frame are defined by the DVB-H standard and in the implementation guide.

Within each data burst, the time difference (ΔT) to the beginning of the next data burst is indicated. Between the data bursts, the data of the elementary stream is not transmitted, allowing other elementary streams to use other allocated bit rates. This enables a demodulator to stay active for only a fraction of the time, during which time it receives bursts of data relating to a requested service. If a constant low bit rate is required at the handheld terminal, the received bursts may be buffered to meet this requirement.

To get a reasonable power saving effect, as indicated above, the burst bit rate should be at least 10 times the constant bit rate of the delivered information/data. In case of a 350 Kbps streaming services, it is recommended that the bursting data be communicated to the receiver at a bit rate of 4 Mbps, for example. Generally, the higher the bit rate of the bursting data, the more economical may be the power consumption. For example, if the burst bit rate is only two times the constant bit rate, this will give rise to only near 50% power saving—which is still far from being satisfactory. Put otherwise, the power consumption largely depends on the duty cycle of the time-slicing scheme. Accordingly, a 10% duty cycle implies a 90% reduction in power consumption. Power saving also depends on how many times, and for how long, the demodulator can be disabled (turned off) during the inactive time slot of a given duty cycle.

As concluded from the discussion above, the time slicing mechanism is a significant feature in the MDTV standard, and therefore for DVB-H devices. A ‘wise’ receiver designer will take advantage of the time-slicing mechanism to shutdown as many functions as possible—essentially the entire receiver, and for the longest possible time—essentially the entire “silence” time (i.e., the time length between consecutive data bursts).

A data burst creates a data structure called the MPE-FEC frame. For a demodulator which is designed to support FEC, the size of this table is typically 2 Mbits. A demodulator which does not require having MPE-FEC capabilities typically requires a smaller table (i.e., a table of up to 1.5 Mbits). During the processing of data within MPE-FEC frame, the integrity of the entire data in the table, or at least the integrity of most of the data in the table, should be maintained.

As a consequence of the requirements above, the MDTV demodulator is required to utilize a memory of at least 2Mbits, and also use it for the time slot at which the demodulator is supposed to be inactive. PCT/IL2004/001082 (“A system circuit and method for utilizing digital memory associated with a host device for received data”) teaches how to utilize an existing memory in the host system rather than a dedicated memory in a receiver. By doing so, it is possible to save 2 Mbits of memory.

Time-slicing, MPE-FEC, 4K mode and in-depth interleavers and DVB-H signaling are more fully described, for example in “ETSI EN 302 304 v1.1.1” (2004-11), “Digital Video Broadcasting (DVB)” and in “Transmission System for Handheld Terminals (DVB-H)”, the entire content of which is herein incorporated by reference.

The objective of the ‘MPE-FEC’ is to improve the channel-to-noise (“C/N”) ratio and Doppler performance in mobile channels, and to improve the receiver's tolerance to impulse interference. This is accomplished by using an additional level of error correction, FEC, at the MPE layer. By adding parity information (i.e., parity bits), calculated from the datagrams, and sending this parity data in separate (i.e., redundant) MPE-FEC sections, error-free datagrams can be output after MPE-FEC decoding, despite possible very bad reception condition. Time slicing, including its use for saving electrical power, and MPE-FEC are also described, for example, in “DVB-H—Mobile TV” (“Imagination Technologies 2005”); “DVB-H architecture for mobile communications systems” (by Stuart Pekowsky and Khaled Maalej, Broadcast/Satellite Communications, April 2005, World Wide Web rfdesign.com); “Digital Video Mobile Broadcast (DVB-H) specification” (Digital Video Mobile Broadcast, Jun. 30, 2005, World Wide Web cellular.co.za/technologies/dvb-h.htm); and in “Transmission System for Handheld Terminals (DVB-H)” (Digital Video Broadcasting, DVB Document A081, June 2004). The structure of an MPE-FEC frame and the way such a frame is processed are also defined/described in the DVB-H standard and in the DVB-H implementation guide.

Although timing slicing extends batteries life of handheld device, there is still a growing need for further reduction in the power consumption of handheld devices, while maintaining high quality reception.

Currently, each data burst that is received by the receiver is analyzed by using CRC, and, based on the CRC analysis, a decision is made by the receiver whether to use Reed Solomon (“RS”) decoder to correct received errors. However, no prediction is involved in the latter process, as each and every data burst has to individually undergo a decision making process, which usually gives rise to wasting (at times) battery power.

### SUMMARY OF THE DISCLOSURE

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure a method of mitigating power consumption in a DVB-H receiver is provided. The method may include predicting reception error(s) associated with a data burst to be received by the receiver, and deciding, based on the prediction result, to process or to eschew processing of MPE-FEC redundancy section(s) associated with the data burst, prior to the reception of the data burst.

According to an embodiment of the present disclosure predicting may include evaluating reception quality before receiving the data burst, and evaluating a reception quality may be performed by either using data provided by the receiver's demodulator, data provided by the MPE-FEC unit in the receiver, or from both. The data so provided may be used to calculate a reception function (F) at the receiver. According to an embodiment of the present disclosure the reception function (F) may be calculated using measured or calculated, scaled or weighted, parameter(s) associated with data received prior to the reception of the data burst.

According to an embodiment of the present disclosure MPE-FEC redundancy section(s) associated with a received data burst may be processed only if the value of the reception function F is greater than a predetermined threshold value. The scaling/weighting factors may be adjusted according to a preferred policy or regime to optimize reception conditions. Prediction may be enhanced by considering reception history, by utilizing reception function. A receiver is also provided, which utilizes the method.

In some embodiments of the present disclosure, the receiver may be a DVB-H type receiver. In general, according to the present disclosure, the receiver may be any receiver that is designed to process received error-correction data identical or similar to the MPE-FEC sections.

In some embodiments of the present disclosure, the DVB-H receiver may conform to the multiprotocol encapsulation forward error correction (“MPE-FEC”) standard, and the redundant data may be redundant sections in MPE-FEC frames.

In some embodiments of the present disclosure, the reception function may be calculated after measuring parameter(s) (for example PDSNR, PM, RSE and Mi) N times, and the reception function may be calculated after averaging the N measurements, wherein N=1, 2, 3, . . . , n.

In some embodiments of the present disclosure, the reception function may be calculated according to one of the following regimes:
a-priori (‘off-line’, at the laboratory);
during regular operation of the receiver (continuously or occasionally); or
during off-time (between bursts, during other time-slices).

In some embodiments of the present disclosure, predicting reception errors may be performed in one of the following regimes:
at/during other time-slices services;
at/during SI (i.e., ‘Service Information’) that may be transmitted intermittently, every few milliseconds; or
at/during the re-synchronization phase, just before the next burst reception.

If the value of the reception function (F) is greater than a predefined threshold value, the next bursting data may be predicted as including error(s). In some embodiments of the present disclosure, predicting the next burst's error-wise behavior is made by considering reception history (Fi).

The method may further include utilizing additional criteria for shutting-down non-essential elements of the receiver. For example, if more than 32 errors are predicted in every single MPE-FEC row, then RS coding with erasures will be used. Otherwise, RS decoding without erasures will be used, for rendering the MPE-FEC table correctable.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a typical DVB-H receiver;

FIG. 2 schematically illustrates incorporation of a mobile digital TV (“MDTV”) feature into a mobile phone;

FIG. 3 schematically illustrates incorporation of an MDTV feature into a portable media player (“PMP”);

FIG. 4 shows typical structure of one MPE-FEC frame;

FIG. 5 shows typical layout of an application data table in a MPE-FEC frame; and

FIG. 6 shows typical layout of RS data table in an MPE-FEC frame.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The disclosure may take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Embodiments of the present disclosure may include apparatuses for performing the operations described herein. This apparatus may be specially constructed for the desired purposes, or it may comprise a general purpose computer selectively activated or reconfigured by a computer program stored in the computer.

Furthermore, the disclosure may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, magnetic-optical disks, a removable computer diskette, a random access memory (RAM), a read-only memory (ROM), a rigid magnetic disk, an optical disk, electrically programmable read-only memories (EPROMs), electrically erasable and programmable read only memories (EEPROMs), magnetic or optical cards, or any other type of media suitable for storing electronic instructions, and capable of being coupled to a computer system bus. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code has to be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosures as described herein.

The Reed-Solomon (“RS”) code is referred to throughout the description. Briefly, Reed-Solomon codes are block-based error correcting codes with a wide range of applications in digital communications and storage. Reed-Solomon codes are used to correct errors in many systems including, for example, wireless or mobile communications (including cellular telephones, microwave links, and so on), satellite communications, digital television/DVB, high-speed modems such as ADSL, XDSL, and so on. RS codes are widely used in error detection and correction. To use RS codes, a data stream is first broken into a series of code words. Each code word may consist of several information symbols followed by several check symbols (also known as ‘parity symbols’, ‘parity data’ or ‘parity bits’). Symbols can contain an arbitrary number of (binary) bits. Once data is received, the decoder checks for and corrects any errors. More information on Reed-Solomon codes and on a polynomials' generator used for creating these codes may be found in “Reed-Solomon Codes: An Introduction to Reed-Solomon codes: principles, architecture implementation” (World Wide Web 4i2i.com/reed_Solomon_codes.htm). The RS decoding is performed twice: the first time in respect of the physical layer and, the second time, in respect of the link layer, when evaluating the errors in the MPE-FEC sections.

Reed Solomon code is advantageously used by the present disclosure in conjunction with the DVB-H standard. However, in cases where other communication standards are used (instead of the DVB-H standard), other suitable coding techniques may be used as well, for example a coding technique known in the field as ‘Turbo’. Alternatively, or additionally, any type of signal processing technique may be used, which is capable of removing data errors caused by various types of communication interferences.

According to the present disclosure, power consumption of handheld devices is mitigated by deciding, ‘on-the-fly’, whether or not to process (at the receiver side) MPE-FEC redundancy section(s) before filtering and sending received internet protocol (“IP”) datagrams to a host controller upon reception of each IP datagram. An IP datagram is constructed from a Protocol Data Unit (“PDU”) or packet from a higher layer protocol such as the Transmission Control Protocol (“TCP”) by inserting a header to the packet. The packet from the protocol at a higher layer then becomes the data of the IP datagram. The header may contain control information, such as the length of the datagram.

As part of the present disclosure decisions may be reached per one or more consecutive data bursts based on prediction of errors in the one or more bursts of data. By deciding not to process MPE-FEC redundancy sections, a further decrease in the power consumption may be obtained because receiver's elements involved in the processing of the MPE-FEC redundancy sections may be shutdown.

In addition, the quality of the communication channel may be evaluated, continually or intermittently, for enhancing the estimation process concerning the processing of the MPE-FEC redundancy sections. That is, if is decided that the communication channel is problematic (e.g., very noisy), a decision may be reached that MPE-FEC redundancy sections will be processed to correct probable errors that might occur due to the problematic communication channel. The quality of the communication channel may be evaluated by using any suitable reception function, as described hereinafter.

A Viterbi Decoder benchmark exploits redundancy in a received data stream to recover the originally transmitted data. The benchmark provides an indication of a potential performance of a microprocessor to be able to process a forward error corrected (“FEC”) data stream using the Viterbi algorithm for decoding. A communication system using a communication channel that is corrupted by noise typically uses FEC to maintain transmission quality and efficiency. One such FEC mechanism includes use of Convolutional encoding at the transmitter end and Viterbi decoding at the receiver end.

Accordingly, the present disclosure provides a method for reducing energy consumption in battery powered mobile (and handheld) receiver while receiving a bursting broadcasted data from a transmitter over a wireless communication channel.

As part of the present disclosure, a reception function may be calculated at the receiver before receiving a next data burst. The reception function may be calculated using parameters that may be associated with previously received data, for example data that is associated with, or derived from, previously received data burst(s). The reception function may assist in predicting reception errors associated with the next data burst prior to its reception. Then, the next data burst may be processed while utilizing, or shutting-down, error-wise redundant data processing elements in the receiver based on the error(s) prediction result. That is, if, according to the reception function, the next data burst is predicted to carry with it erroneous data, the error-wise redundant data processing elements in the receiver will be activated to correct the erroneous data portion(s). If, however, it is predicted that the next data burst is flawless (i.e., it is error-free), the error-wise redundant data processing elements in the receiver will be automatically shutdown to save battery power, because there is no need to process redundant data to reconstruct, or correct, the originally transmitted data.

The receiver may ‘learn’ the characteristics of the involver communication channel in order to lower the probability that it would reach false error predictions. This may be accomplished by the receiver measuring reception parameters and using the measured parameters to calibrate the receiver for optimal reception, to compensate, at least to some extent, for the noisy communication channel.

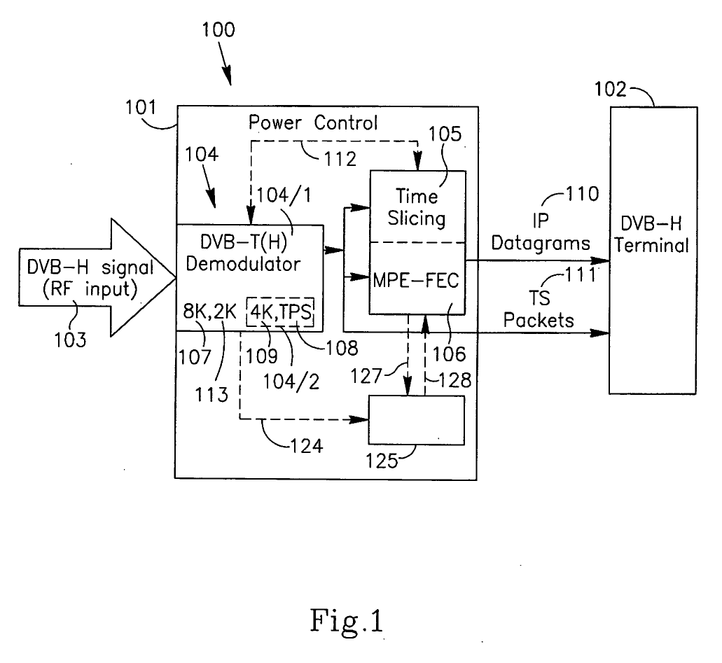

FIG. 1 is a block diagram of an exemplary structure of a DVB-H receiver (generally shown at 100). A DVB-H receiver typically includes a DVB-H demodulator 101 and a DVB-H terminal 102. DVB-H demodulator 101 typically includes, among the other things, a DVB-H demodulator (shown at 104) which includes a DVB-T demodulator 104/1 that is enhanced by additional functionality (marked as 104/1, for brevity), a time-slicing module (shown at 105) and an MPE-FEC module (shown at 106), the tasks of which are described hereinbefore and, additionally, hereinafter.

DVB-H system 100 typically consists of service information and elements in the physical layer and in the link layer. DVB-H makes utilizes time slicing 105 and MPE-FEC 106 for the link layer, and DVB-H signaling, 8K-mode (shown at 107) and in-depth symbol interleaver for the physical layer. DVB-H system 100 also utilizes signaling in the Transmitter Parameter Signaling (“TPS”) bits (shown at 108) to enhance and speed up service discovery. Cell identifier is also carried on TPS-bits 108 to support quicker signal scan and frequency handover on mobile receivers. 4K-mode (shown at 109) is used by DVB-H system 100 for trading off between mobility and Single Frequency Network (“SFN”) cell size, for allowing single antenna reception in medium SFNs at very high speed, adding thus flexibility in the network design.

In-depth symbol interleaver is used for the 2K and 4K-modes (shown 113 and 109, respectively) for further improving robustness in mobile environment and impulse noise conditions. To provide DVB-H services, time slicing 105, cell identifier and DVB-H signaling (shown at 108) are mandatory, whereas other technical elements may be combined arbitrarily, according to specific needs. It is noted that the payload of DVB-H system 100 is Internet Protocol (“IP”) datagrams (shown at 110) or other network layer datagrams encapsulated so as to form, or create, MPE-sections.

A Transport Stream (“TS”) may contain data relating to video, audio, teletext, service information, conditional access information, and so on. Transport Stream consists of TS packets 111. Each packet of TS packets 111 is 188-byte long and contains a header and a payload section. The header of each TS packet 111 contains information about the contents of that packet and is intended for a TS de-multiplexer (not shown) in DVB-H terminal 102. The payload section contains the actual audio, video, teletext, and the like, data. The header typically starts with a synchronization word that is used for recognizing the start of the TS packet. Two bytes may follow the synchronization word, which contain some flags and the Packet ID (“PID”).

The input signal to DVB-H demodulator 101 is a DVB-H signal (shown at 103) that includes time-sliced radio frequency (“RF”) signal. As explained hereinbefore, time slicing involves sending data in bursts using a significantly higher bit rate compared to the bit rate required if the data were transmitted continuously. Within each data burst, the time difference (ΔT) to the beginning of the next data burst is indicated. At “off-time”, which is the time between two consecutive time-sliced bursts, data relating to the elementary stream is not transmitted for allowing other elementary streams to use other allocated bit rates. This feature enables a demodulator to stay active for only a fraction of the time, during which time it may receive data bursts relating to a requested service. If a constant low bit rate is required at the handheld terminal 102, the received data bursts (203) may be buffered to meet this requirement.

A data burst creates a data structure called an MPE-FEC frame. For demodulator 104, which is designed to support FEC, the size of the MPE-FEC frame (sometimes referred to as “table”) is typically 2 Mbits. A demodulator which does not require MPE-FEC capabilities typically requires a smaller table (a table of up to about 1.5 Mbits). During the processing (by MPE-FEC module 106) of data residing within MPE-FEC frame, the integrity of the entire data in the table, or at least the integrity of most of the data in the table, should be maintained. The MPE-FEC frame and the way it is processed are defined in the DVB-H standard and in the DVB-H implementation guide.

DVB-T demodulator 104 recovers Moving Picture Experts Group (“MPEG”)-2 TS packets (shown at 111) from the received signal 103, and forwards them (shown at 111) to DVB-H terminal 102 for display. DVB-T demodulator 104 offers three transmission/reception modes, 8K (shown at 107), 4K (shown at 109) and 2K (shown at 113). To each mode a corresponding Transmitter Parameter Signaling (TPS) 108 is used. IP datagrams 110 typically include data that may be played by DVB-H Terminal 102. Time-slicing 105 extracts from the RF signal demodulated by DVB-H demodulator 104 start and end instants of received (shown at 103). data bursts for synchronizing the processing of the MPE-FEC sections by MPE-FEC 106.

As explained hereinbefore, MPE-FEC frames are transmitted in data bursts so that the receiver, or selected parts thereof, can be shut down, or mute. For example, DVB-H demodulator 104 may be mute by Time Slicing 105, for example, between each two consecutive MPE-FEC transmission data bursts. Time-slicing module 105 and DVB-H demodulator 104 are schematically shown connected by control line 112, to reflect the power consumption of the DVB-H demodulator 104 being controlled in accordance with the timing slicing feature described herein, while allowing performing smooth and seamless frequency handover. MPE-FEC unit 106 (the functionality of which is introduced by the DVB-H standard) offers (over the physical layer transmission) a complementary forward error correction (FEC) feature, which allows the receiver to cope with particularly difficult receiving conditions.

As described hereinbefore in connection with the principles disclosed herein, a decision is reached as to if and when to shutdown circuitries belonging to or associated with MPE-FEC unit 106. According to the present disclosure, controller 125 receives data from the DVB-H demodulator 104 that allows controller 125 to calculate the reception function (F) mentioned hereinbefore, for evaluating the communication's quality of the communication channel. In addition, controller 125 may obtain (shown at 127) from MPE-FEC unit 106 data relating to errors in the received data. Based on the data received (shown at 124) from DVB-H demodulator 104 and/or on data received (shown at 127) from MPE-FEC, controller 125 may reach a decision as to whether to shutdown or mute (shown at 128) controllable MPE-FEC unit 106, or selected circuit elements thereof, and/or other selected circuit elements.

As a handheld device is required to consume low power, it would be beneficial to operate or enable its components only in periods during which they should be involved in a specific signal-processing phase. Otherwise, these components should be disabled (turned off) to preserve battery power; that is, if disabling these components does not disturb the service currently requested by, or rendered to, the device's user. For example, it may be of interest to put the display of the device into sleep mode whenever there is no essential information to present to the user. Alternatively, or additionally, it may be beneficial to shut down DVB-T(H) Demodulator 104 or portions thereof when no data is expected to be received (by the receiver, not shown, including DVB-T(H) Demodulator 104) at that particular time instance or during that particular period. During such inactive periods, it might be required, however, to maintain background processes such as to execute real time operations (for example timers, responses to external requests, re-adjust parameters, acquire better quality RF signals, and so on), and to maintain data or parameters integrity by storing them, for example in a RAM.

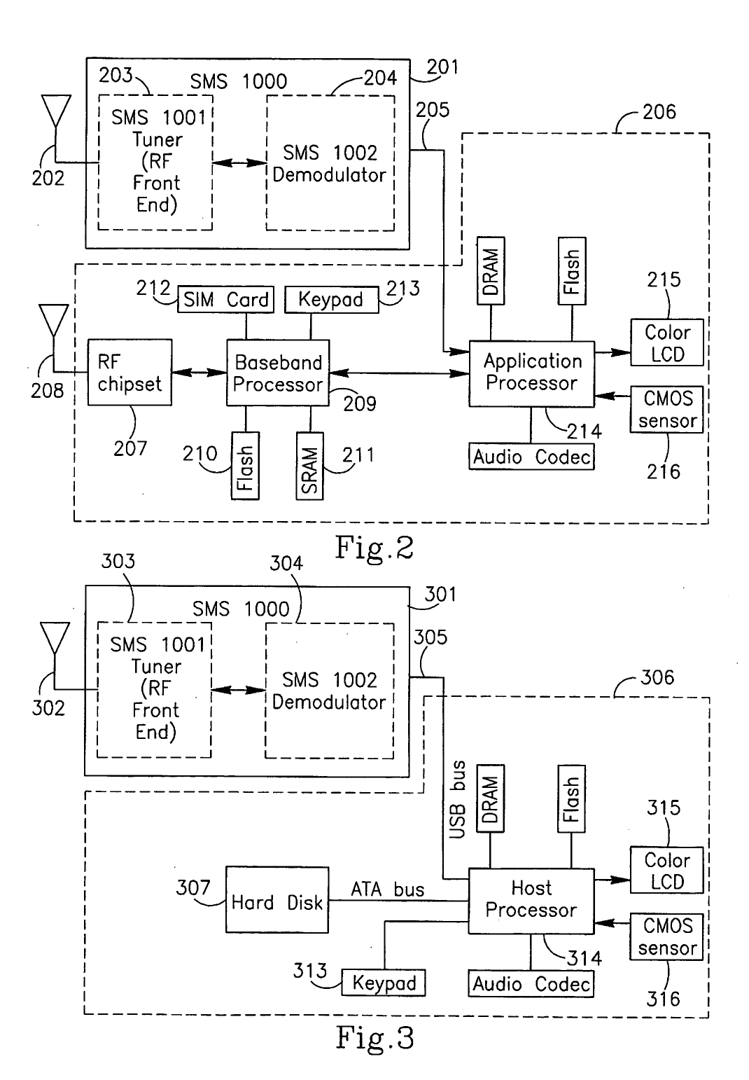

A typical mobile digital television (“MDTV”) demodulator (generally shown at 101 in FIG. 1), which may conform to the DVB-H standard, is shown integrated with a mobile phone (generally shown at 206 in FIG. 2), and with a portable media player (“PMP”) (generally shown at 306 in FIG. 3).

Referring again to FIG. 2, it shows a block diagram of a typical mobile digital television (“MDTV”) demodulator (generally shown at 201), which may conform to the DVB-H standard, that is integrated with a mobile phone (generally shown at 306) functionality. A DVB-H signal may be received at antenna 202 and output by tuner 203 to demodulator 204 that may be a demodulator such as demodulator 101 of FIG. 1.

Exemplary mobile phone 206 is shown consisting of an RF chipset 207 for amplifying and filtering telephonic signals that may be received at antenna 208, and a baseband processor 209, which is coupled to Flash memory 210, serial random access memory (“SRAM”) 211, SIM card 212 and keypad 213. Typical mobile phone 206 is also shown consisting of an application processor 214, which is coupled, among other things, to color liquid crystal display (“LCD”) 215. Being exemplary mobile phone, each element unit or component in mobile phone 206 may be substituted with a similar, or equivalent, element unit or component. For example, keypad 213 may be substituted with any suitable input device such as a keyboard, camera, touch screen, microphone, and so on. Likewise, display screen 215 is not necessarily color or LCD, and sensor 216 is not necessarily of the CMOS type.

MDTV demodulator 201 may forward (shown at 205) IP datagrams to application processor 214. If the IP datagrams are associated with television broadcast, then application processor 214 may generate from the IP datagrams a signal representative of the television images and send the signal to color LCD 215 for display. By using keypad 213, for example, a user of the device may use the device as a telephone or as a television set to watch a television program on color LCD 215.

Integration of a MDTV modulator in a handheld terminal (such as mobile phone 206 or portable media player (PMP) 306 of FIG. 3) usually results in additional power consumption, which is problematic in terms of power consumption. The power limitation results from the limited battery capacity and the heat dissipation in a miniaturized environment. Having being adapted to the mobile environment, the additional power consumption required to operate the MDTV modulator is limited to less than 10% of the expected nominal power consumption of a standard digital TV receiver that consists of RF tuner and baseband demodulator.

Fortunately, services used in handheld terminals involve communications of data streams that are characterized by having relatively low bit rates. The estimated maximum bit rate for streaming video information using advanced compression technology (e.g., MPEG-4) is in the order of a few hundreds kilobits per second (“Kbps”). For example, one practical limit is 384 Kbps, which is a typical bit rate in the third generation (“3G”) standard. ‘3G’ is a short term for third-generation wireless, and refers to recent and near-future developments in personal and business wireless technology, especially mobile communications. ‘3G’ includes capabilities and features such as enhanced multimedia (voice, data, video, and remote control); usability on all popular modes (cellular telephone, e-mail, paging, fax, videoconferencing, and Web browsing); broad bandwidth and high speed (upwards of 2 Mbps); routing flexibility (repeater, satellite, LAN); and operation at approximately 2 GHz transmit and receive frequencies.

A popular digital video transmission standard is the DVB-T, commonly used by demodulators for stationary TV reception. DVB-T transmission system usually provides a bit rate of up to 32 Mbps. The DVB-H standard is used by handheld demodulators, usually for mobile TV reception, and significantly reduces the average power consumption of a DVB receiver by introducing a scheme based on time division multiplexing (“TDM”), also known to those skilled in the art as ‘time-slicing’.

Referring again to FIG. 3, it shows a general block diagram of a typical mobile digital television (“MDTV”) demodulator (generally shown at 301), which may conform to the DVB-H standard that is integrated with a portable media player (“PMP”) 306. A DVB-H signal may be received at antenna 302 and output by tuner 303 to demodulator 304 that may be a demodulator such as demodulator 101 of FIG. 1.

PMP 306 is shown comprising a hard disk (shown at 307) for storing various types of multimedia data, and a keypad (shown at 313). Typical PMP 306 is also shown comprising a host processor 314, which is coupled, among other things, to a color liquid crystal display (“LCD”) 315. MDTV demodulator 301 may forward (shown at 305) IP datagrams to application processor (HOST Processor) 314. If the IP datagrams are associated with to a television broadcast, then application processor 314 may generate from the IP datagrams a signal representative of the television images and send the signal to color LCD 315 for display. By using keypad 313, for example, a user of the device may use the device as a multimedia player or as a television set to watch a television program on color LCD 315. Being exemplary portable media player, each element unit or component in portable media player 306 may be substituted with a similar, or equivalent, element unit or component. For example, keypad 313 may be substituted with any suitable input device such as a keyboard, camera, touch screen, microphone, and so on. Likewise, display screen 315 is not necessarily color or LCD, and sensor 316 is not necessarily of the CMOS type.

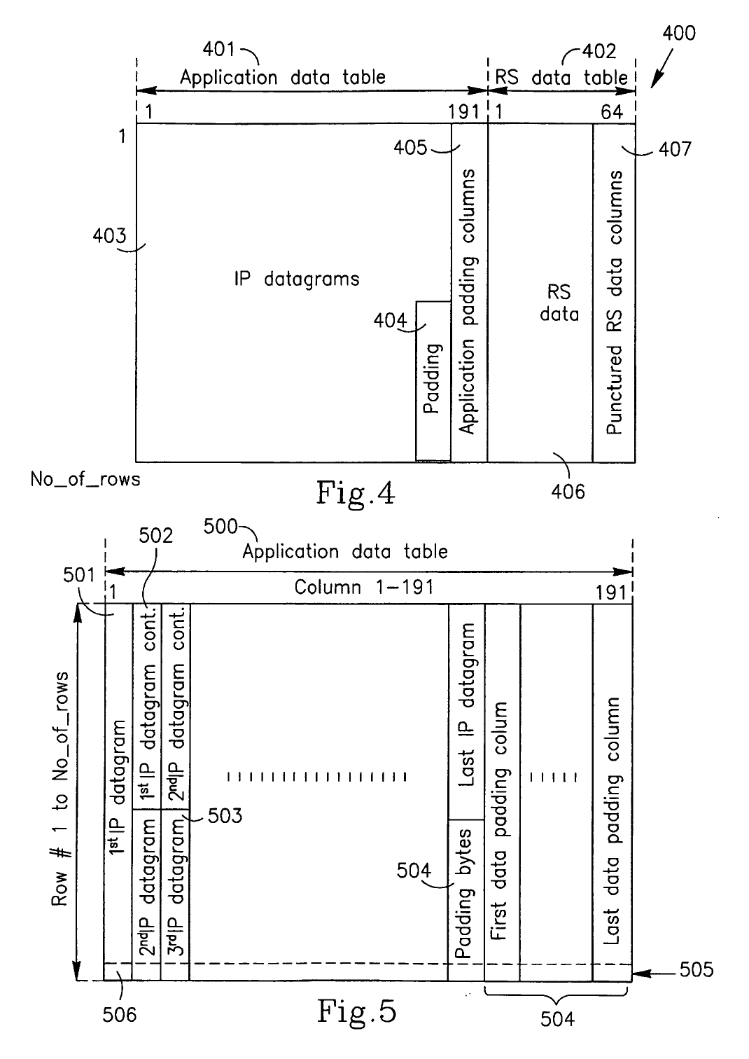

Referring now to FIG. 4, an exemplary general structure of an MPE-FEC frame (generally shown at 400) is shown, which is arranged as a matrix with 255 columns and a dynamic, or flexible number of rows. A typical MPE-FEC frame consists of an application data table (shown at 401) and a Reed-Solomon (RS) data table (shown at 402). The application data table (shown at 401) contains 191 columns (designated 1 through 191) that contain Internet Protocol (IP) datagrams 403 relating to a multimedia content being broadcasted. Depending on the byte-wise length of IP datagrams 403, padding bytes may have to be used to complete the designated number columns in table 401. For example, application data table 401 is shown containing one column partially padded (shown at 404) and additional padded columns (shown at 405).

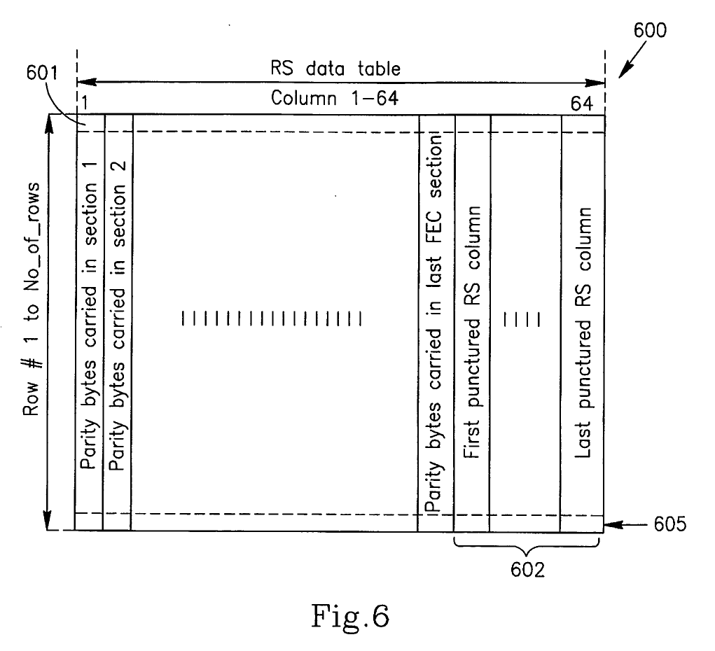

RS data table 402 contains 64 columns (designated 1 through 64) that contain Reed-Solomon data 406 that may be used for correcting MPE-FEC sections. Depending on the number of erroneous MPE-FEC sections detected, some of the columns in RS data table 402 may. include punctured RS data columns (shown at 407). An exemplary RS data table is shown in FIG. 6 (at 600).

The number of rows in the table may vary from 1 to a value signaled, indicated or specified in a “time_slice_fec_identifier_descriptor”. In general, the time_slice_fec_identifier_descriptor announces to the receiver the use of time slice and forwards to it optional MPE-FEC data in the way specified in EN 301 192 [3]. The maximum allowed number of rows in an MPE-FEC frame is 1024, which makes the total MPE-FEC frame as large as 2 Mb. Each entry in the matrix may contain an information byte. RS data 506 are dedicated for the parity information of the FEC code. Each byte entry in the application data table 401 has an address ranging from 1 to 191×no_of_rows. Similarly, each byte position in the RS data table 402 has an address ranging from 1 to 64×no_of_rows. Addressing in RS table 402 is redundant because section_length and section_number are known.

IP datagrams are transmitted one datagram at a time, starting with the first byte of the first datagram in the upper left corner of the matrix and going downwards the first column, as exemplified in FIG. 5. The bit-wise length of IP datagrams 403 may vary arbitrarily, according to the actual data content, from one IP datagram to another, depending on the transmitted information, or multimedia content. For example, the first IP datagram (“1^{st} IP datagram”) (shown at 501 in FIG. 5) is shown occupying about a full column and a half (shown at 502 in FIG. 5). Likewise, the third IP datagram (“3^{rd} IP datagram”) (shown at 503 in FIG. 5) is shown occupying about one half of a column. After the transmission of one IP datagram ends, the transmission of a following IP datagram starts. If an IP datagram does not end precisely at the end of a column, it continues at the top of the following column. When all IP datagrams have been entered into the application data table 500 of FIG. 5, any unfilled byte positions (shown at 504 in FIG. 5) are padded with zero bytes, which make the leftmost 191 columns completely filled. The number of padding columns in each MPE-FEC frame is signaled dynamically (to the receiver) in the MPE-FEC section. This signaling is typically implemented by using eight dedicated bits.

Referring again to FIG. 5, a Reed Solomon decoder corrects data in application data table 500 one row after another. The Reed Solomon decoder typically processes a plurality of rows in an application data table such as application data table 500, one exemplary row, row 505, is generally referenced in FIG. 5. Data byte 506, therefore, resides in column 501, row 505.

With all the leftmost 191 columns filled it is now possible, for each row, to calculate the 64 parity bytes from the 191 bytes of IP data (and possible padding bits). The code used for this purpose is a code known in the field as the Reed-Solomon code (255,191), with a field generator polynomial and a code generator polynomial as defined hereinafter. Each row, then, is associated with one RS codeword. Some of the rightmost columns of the RS data table may be discarded and, therefore, not transmitted, to enable “puncturing”. The exact number of punctured RS columns may change from one MPE-FEC frame to another, and it does not need to be explicitly signaled to the receiver. The RS data table (502) is also filled with punctured RS columns, to completely fill the MPE-FEC frame, as schematically illustrated in FIG. 6.

Referring again to FIG. 6, there is schematically exemplified a RS data table (generally shown at 600). RS data table 600 is shown consisting of 64 columns (1 through 64), each column containing parity bytes that are associated with a respective FEC section. The process by which the RS decoder corrects sections includes, among other things, handling one row after another in the MPE-FEC table, such that for each row in the application data table 500 in FIG. 5, the RS decoder utilizes parity bytes in the corresponding row in the RS data table 600. In general, the RS decoder corrects rows in application data table 500 by utilizing parity bytes in the respective rows in the RS data table 600. For example, the RS decoder may correct the last row (shown at 505 in FIG. 5) in application data table 500 by utilizing the parity bytes in the corresponding (last) row (shown at 605) in RS data table 600. Portion 602 of RS data table 600 may contain punctured RS columns.

The code generator polynomial may be calculated, for example by:
g(x)=(x+α⁰)(x+α¹), . . . , (x+α²)(x+α⁶³)

where α=02 (in HEXADECIMAL)

The field generator polynomial may be calculated, for example by:
p(x)=x⁸+x⁴+x³+x²+x²+1

IP datagrams are encapsulated in MPE sections in the standard DVB manner, irrespective of whether MPE-FEC measures are used or not. This renders the reception fully backwards compatible with MPE-FEC ignorant receivers. Each section carries a start address for the IP datagram, which is carried within the section. This start address indicates the byte position in the application data table of the first byte of the IP datagram and is signaled in the MPE header. The receiver will then be able to put the received IP datagram in the right byte positions in the application data table and mark these positions as ‘reliable’ for the RS decoder, provided that the CRC-32 indicates that the section is correct. The CRC-32 checksum calculation is based on a cyclic redundancy check (“CRC”) technique as described; E.G., in ISO 3309 [14].

The last section of the application data table contains a ‘table_boundary’ flag, for indicating the end of the IP datagrams within the application data table. If all previous sections within the application data table have been received correctly, the receiver does not need to receive any MPE-FEC (redundant) sections and, if time-slicing is used, the receiver can go to ‘sleep’ mode without receiving and decoding RS data.

In cases where MPE-FEC sections are received, the exact number of padding columns in the application data table is indicated (i.e., signaled using 8 dedicated bits) in the section header of the MPE-FEC sections. The number of padding columns is needed only if RS decoding is performed.

The parity bytes are carried in a separate, specially defmed section type, with it's own indicator (i.e., ‘table_id’). Parity bytes are similar to MPE sections and are named ‘MPE-FEC sections’. The length of a MPE-FEC section is adjusted so that there is exactly one section per column. Punctured columns are not transmitted and not signaled explicitly.

The number of rows is signaled in the ‘time_slice_&_fec_identifier_descriptor’ but can also be determined from the ‘section_length’ of the MPE-FEC sections, because the payload length of these sections is equal to the number of rows. In this way, there is always exactly one section per column. The number of punctured RS columns can be calculated as 64—‘last_section_number’, because the ‘last_section_number’ indicator indicates the number of sections and therefore the number of columns.

The receiver introduces the number of application data padding columns with zero bytes, which is indicated dynamically by the MPE-FEC sections, and marks these MPE-FEC sections as reliable sections. If the receiver receives the ‘table_boundary’ flag correctly, it can also add any remaining padding bytes and mark these as reliable. Otherwise, these MPE-FEC sections will be regarded as unreliable, in the same way as other lost data. The receiver also introduces the number of punctured RS columns as calculated from ‘last_section_number’. The actual data in the punctured RS columns are irrelevant, as all punctured data are considered unreliable.

All MPE and MPE-FEC sections are ‘protected’ by a CRC-32 code, which reliably detects almost all erroneous sections. Usually, only a negligible number of erroneous sections will not be detected by the CRC-32 code. For every correctly received section belonging to the application data table or to the RS data table, the receiver seeks in the section header for the start address of the payload within the section and is then able to put the payload in the right position in the respective table. Note that MPE sections may optionally contain a checksum procedure instead of a CRC-32. However, CRC-32 is preferred over the checksum procedure.

After the latter procedure is done, there still may be a number of lost sections. All correctly received bytes, including application data padding, can then be marked as ‘reliable’ and all byte positions in the lost sections, and in the punctured RS columns, can be marked as ‘unreliable’ in the RS decoding.

All byte positions within the MPE-FEC frame (application data table+RS data table) are now marked as either ‘reliable’ or ‘unreliable’. With such reliability (erasure) information, the RS decoder is able to correct up to 64 such unreliable bytes per 255-byte codeword.

If there are more than 64 unreliable byte positions in a row, the RS decoder will not be able to correct anything and will therefore typically just output the byte errors without error correction. After completion of the RS decoding, the receiver will reliably ‘know’ the positions of any remaining erroneous byte within the MPE-FEC frame. If an IP datagram is only partly corrected, the receiver will be able to detect this and (optionally) to discard this datagram.

In addition to the CRC-32, which detects erroneous sections, the DVB-H RS decoder also reliably detects erroneous TS packets. If the MPEG-2 demultiplexer discards erroneous packets, it could be configured not to build sections that are suspected as containing lost TS packets. In this way, only correct (i.e., reliable) sections would be built and the role of the CRC-32 would be to provide additional error detection functionality, which normally is not needed. Seldom, it may occur that the DVB-H RS decoder fails to detect an erroneous TS packet, which also happens to have the right Program ID, and that an erroneous section therefore could be reconstructed. In these cases, the CRC-32 would discover such a section error.

By introducing a certain number of zero-valued application data padding columns in the rightmost part of the application data table, it is possible to make the code stronger, meaning that more actual errors could be corrected. For example, one may autocorrect the zeros and than use the error correction for the other non-zero bytes. These padding columns are only used for the calculation of parity bytes; i.e., they are not transmitted. In the receiver they are reintroduced and marked as ‘reliable’ for the RS decoder. With, for example, 127 padding columns, there are 64 columns left for IP data. With the 64 parity columns the effective code rate of the code becomes ½. However, the price for this is the effective codeword length being roughly decreased by 50%. The number of application data padding columns is dynamic and specified in the MPE-FEC sections. The allowed range of padding columns is 0-190.

An effectively weaker code may be achieved by puncturing. Puncturing is performed by discarding one or more of the last RS data columns. The number of discarded (punctured) RS columns may vary dynamically between MPE-FEC frames within the range [0-64] and can be calculated as 64—‘last_section_number’, except for the case where no RS columns are transmitted (puncturing is 64 columns). Puncturing will decrease the overhead introduced by the RS data and thus decrease the needed bit rate. The drawback of puncturing is that it is a weaker code.

According to the present disclosure, a method is provided, which allows a DVB-H receiver to decide in advance, “on-the-fly”, whether or not to process redundancy sections in MPE FEC frames. If the redundancy sections are ignored, each related IP datagram is filtered and sent to the receiver's host immediately upon reception thereof. The method of the present disclosure allows the receiver to predict, for each burst or for a group of consecutive bursts, weather MPE-FEC ‘activation’ will have no impact on the quality of the signal. In other words, if no errors are currently predicted, or expected, from the input to the MPE-FEC, in respect of the next data burst, the corresponding MPE-FEC frames will not be processed. If, however, errors are predicted, MPE-FEC will be activated as usual, though in this case MPE-FEC might be eventually ignored as well as a result of CRC code calculations.

In most cases, when the prediction is positive (i.e., no errors are predicted), it generally means that the channel is at least fairly good or that the receiver is located in a pseudo stationary environment, such as when a user watches a TV broadcast in a stationary fashion. When the prediction is negative it generally means that the receiver is mobile or the communication channel is very noisy.

In a stationary environment, it is reasonable to require from the receiver to have a performance equivalent to the performance of a typical DVB-T receiver, which is characterized by having a quasi error free reception bit-error-rate (“BER”) of 1e-11. Because an MPE-FEC table contains 1.5 Mbits of information, in pseudo-stationary environment only 1 out of 66,666 received MPE-FEC tables will possibly have an error.

The modem of a DVB-H receiver may perform measurements and generate instantaneous metrics based on the measurement results, which give indication about the quality of the received signal. Traditionally, these metrics are used for monitoring, debugging and for controlling control loops in the modem. The measurements may be associated with the following parameters (the following list not being exhaustive):
Post detection signal to noise ratio (PDSNR) of the de-mapped signal;
Path metric of the surviving path at the Viterbi decoder (PM);
The number of errors at the physical layer RS decoder (RSE);
Other metrics (Mi), where i take the index of the metric number.
   A reception function (F) may be formulated from the measurements, as follows:
   F=ƒ{PDSNR,PM,RSE,Mᵢ}

Different, or additional, elements may be used in ƒ { , . . , } to calculate F, such that each element may relate, directly or indirectly, to different probable types of communication interference. For example, one such function element may relate to noisy impulses. Another exemplary element may relate to the transmission power, etc.
An exemplary reception function F may be:

$$F = α \frac{1}{PDSNR} + β PM + γ RSE + {δ}_{i} {M}_{i}$$

where α, β, γ and δ are scaling/weighting factors/parameters which may be found as described hereinafter.

Parameters/factors α, β, γ and δ have no units and may have arbitrary values, including zero. If the function F gets a value bigger than a predefined threshold value (TSH) than it may be predicted that the corresponding data burst (meaning the related MPE-FEC frame/section) contains errors. Otherwise, the data burst may be assumed to be error-free.

According to some embodiments of the present disclosure, the method may involve two main phases: adaptation phase and prediction phase. In the adaptation phase, the receiver may ‘learn’ the quality, and other characteristics, of the involved communication channel and calibrate, or adjust, the scaling/weighting parameters/factors so that the receiver will substantially not generate miss predictions and/or false alarms. The calibration phase may include (among other things): collecting measurements (associated with the exemplary parameters PDSNR, PM, RSE and Mi) and storing them in the ‘i’ 'th column of a the metric Matrix; calculating CRCs codes at the MPE-FEC and determining weather the MPE-FEC table is error-free; storing the result in the ‘i’ 'th row of the status column; repeat the steps of collecting measurements and calculating CRCs codes N times, for different channel conditions; and extracting the scaling/weighting parameters by inverting the metric matrix, as follows:

$$[ α , β , γ , δ ] [ \begin{matrix}{PDSNR}_{1} & {PDSNR}_{2} & {PDSNR}_{3} & {PDSNR}_{4} \\ {PM}_{1} & {PM}_{2} & {PM}_{3} & {PM}_{4} \\ {RSE}_{1} & {RSE}_{2} & {RSE}_{3} & {RSE}_{4} \\ {M}_{1} & {M}_{2} & {M}_{3} & {M}_{4}\end{matrix} ] = [ \begin{matrix}{S}_{1} & {S}_{2} & {S}_{3} & {S}_{4}\end{matrix} ]$$

where Si may be ‘0’ or ‘1’. S1 to S4 result from the CRC-32 process.

Each entry in the matrixes above can be obtained by averaging the instantaneous value of several measurements, in order to accommodate for noisy measurements.

The adaptation phase may be implemented in one or more of the following policies, regimes or ways:
a-priori (offline, at the laboratory);
at/during regular operation of the receiver (continuously or occasionally); or
at/during off time (between bursts, during other time-slices).

At the prediction phase, it is assumed that the scaling/weighting parameters are known and supposed to yield minimum false predictions or miss predictions.

Before receiving a next burst, the metrics associated with it are collected. Preferably, though not necessarily, the metrics are collected and averaged over ‘N’ measurements, to compensate for noisy measurements. If F has a value that is greater than TSH, it is assumed that the MPE-FEC is going to be erroneous and, hence, the MPE-FEC procedure is going to be taken. Otherwise, it is assumed that the forthcoming data burst is error-free and, hence, the received IP datagrams are filtered and sent to the host one datagrams at a time.

Preferably, though not necessarily, the actual prediction may be temporally made as close as possible to the time at which the data burst of interest (the next data burst to be received) is anticipated, in order to accommodate for characteristics changes relating to the communication channel. Accordingly, the prediction may be implemented at one or more of the following occasions, or according to one (or more) of the following policies:
at/during other time-slices services;
at/during SI (transmitted continuously every few milliseconds) reception; and/or
at/during the re-synchronization phase, just before the burst is received.

Alternatively, or additionally, reception history may be factored in for the purpose of error prediction. If, for quite a while, the reception quality was recently as high as the reception quality of a pseudo stationary receiver, it is most likely that it will still be that good for the current data burst. The reception history may be manifested, for example, by using the following expression:
Fᵢ=μ*ƒ{ . . . }+(1−μ)*Fᵢ₋₁ (where 0<μ≦1)

It may occur, however, that the current measurement is “too big” relative to the reception history, which may indicate a sudden change in the communication circumstances. The sudden change in the communication circumstances may be caused; for example by noticeable fast movements of the user of the receiver. Under such circumstances, it would make sense to disregard any reception history.

In case it is predicted that there will be errors in the received MPE-FEC, an additional set of scaling/weighting parameters, and possibly additional threshold values, may be utilized to predict whether there will be more than 32 errors in every single MPE-FEC row, or less than 32 errors. If more than 32 errors are predicted, the receiver will use, according to the present disclosure, RS decoding with erasures. Otherwise, the receiver will use, according to the present disclosure, RS decoding without erasures. The benefit of this is that in case of a relatively small number of errors, if erasures are considered, entire MPE sections are erased due to CRC failure. This might lead to uncorrectable MPE-FEC table. However, using RS decoding without erasures will render the MPE-FEC table correctable.

Turning again to FIG. 1, whenever a prediction is reached that the next data burst is error-free, corresponding control signal (shown at 112) may be forwarded from MPE-FEC module 106 to DVB-T(H) Demodulator 104, to shut-down, or mute, selected circuit elements that are normally (traditionally) involved in the processing, or correcting, of erroneous MPE-FEC sections.

Mobile and handheld communication devices, for example cellular phones and personal digital assistant (PDAs) devices, may utilize the principles disclosed herein for extending their batteries' life.

A system is also provided, which includes a transmitter that wirelessly broadcasts multimedia and other types of data/information to a receiver according to the DVB-H standard, where the receiver shutsdown error-correction circuit element(s) upon prediction of errors in the data streaming from the transmitter. Optionally, the receiver may also shutdown error-correction circuit element(s) upon identifying reception problems relating to the communication channel, based on reception parameters, such as signal-to-noise ration (“SNR”).

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of mitigating power consumption in a receiver processing data bursts, comprising:
predicting reception error(s) associated with a data burst to be received by said receiver; and
deciding, based on the prediction result, to process or to eschew processing of MPE-FEC redundancy section(s) associated with said data burst, prior to receiving said data burst.

2. The method according to claim 1, wherein predicting comprises evaluating future reception quality before receiving the data burst, by using data provided by the receiver's demodulator.

3. The method according to claim 2, wherein evaluating is based on calculating a reception function (F) at the receiver.

4. The method according to claim 3, wherein the reception function is evaluated using measured or calculated, scaled or weighted, parameter(s) associated with data received prior to the reception of the data burst.

5. The method according to claim 4, wherein the data received prior to the reception of the data burst is associated with, or derived from, previously received data burst(s).

6. The method according to claim 4, wherein the data received prior to the reception of the data burst is associated, or derived from, data received between previously received data bursts.

7. The method according to claim 3, wherein MPE-FEC redundancy section(s) are processed only if the value of the reception function is greater than a predetermined threshold value.

8. The method according to claim 1, wherein decisions are reached per one or more consecutively received data bursts based on prediction of error(s) in said one or more data bursts.

9. The method according to claim 4, wherein the parameters are selected from a group of parameters comprising {post detection signal-to-noise ratio of the ‘de-mapped’ signal (PDSNR), path metric of the surviving path at the Viterbi decoder (PM), the number of errors at the physical layer RD decoder (RSE), and other metrics (Mi)}.

10. The method according to claim 4, wherein the value of the reception function (F) is calculated in the following way:
F=α*(1/PDSNR)+β*(PM)+γ*(RSE)+δᵢMᵢ
wherein α,β,γ, δ and are scaling/weighting factors.

11. The method according to claim 10, wherein the parameters PDSNR, PM, RSE and Mi are calculated N times for optimizing α,β,γ and δ to accommodate to a noisy communication channel.

12. The method according to claim 10, wherein adjusting the values of α, β,γ and δ may occur:
a-priori, (in offline, at the laboratory);
at/during regular operation of the receiver; or
at/during off time, between data bursts or during other time-slices.

13. The method according to claim 1, wherein the prediction may be performed:
at or during other time-slices services;
at or during Service Information that may be transmitted intermittently every few seconds; or
at or during the re-synchronization phase just before receiving the next data burst.

14. The method according to claim 1, further comprising enhancing the prediction by considering reception history (Fi).

15. The method according to claim 14, wherein the reception history (Fi) is calculated using the following expression:
Fᵢ=μ*ƒ{ . . . }+(1−μ)*Fᵢ₋₁
wherein 0<μ≦1, ‘Fᵢ’ designates a weighted value (the value of the reception function F) relating to the reception quality of a currently received data burst, ‘ƒ{ . . . }’ designates a value relating to the reception quality of a currently received data burst, and ‘Fᵢ₋₁’ designates a weighted value (the value of data burst(s) immediately preceding the current measurement.

16. The method according to claim 1, wherein if more than 32 errors are predicted in every single MPE-FEC row in the involved MPE-FEC table, Reed-Solomon coding with erasures are used, else Reed-Solomon coding without erasures are used.

17. The method according to claim 1, wherein the receiver is a Digital Video Broadcasting (DVB) Handheld receiver, or it complies with the DVB-H standard or is designed to process received error-correction data identical or similar to the MPE-FEC sections.

18. The method according to claim 1, wherein predicting is based on data provided by the receiver's MPE-FEC functionality.

19. A receiver capable of processing data bursts, comprising:
a controller adapted to predict reception error(s) associated with a data burst to be received by said receiver, and to decide, based on the prediction result, whether to enable circuit elements prior to receiving said data burst.

20. The receiver according to claim 19, further comprising:
a demodulator adapted to forward to the controller data relating to reception quality; and
a controllable MPE-FEC unit adapted to forward to said controller data relating to errors in received data burst(s),
wherein said controller decides to enable or disable selected circuit element(s) of said MPE-FEC unit based on data received from said demodulator, or from said MPE-FEC unit, or based on reception history (Fi).

21. The receiver according to claim 20, wherein the controller shuts down or mutes circuit element(s) associated with the processing of MPE-FEC redundancy section(s) associated with the data burst yet to be received.

22. The receiver according to claim 19, wherein the controller predicts reception error(s) based on the evaluation of future reception quality and before receiving the data burst.

23. The receiver according to claim 22, wherein the controller predicts reception error(s) by calculating a reception function (F) associated with reception quality.

24. The receiver according to claim 23, wherein the controller calculates the reception function using measured or calculated, scaled or weighted, parameter(s) associated with data received prior to the reception of the data burst.

25. The receiver according to claim 24, wherein the data received prior to the reception of the data burst is associated, or derived from, previously received data burst(s) or data received between previously received data bursts.

26. The receiver according to claim 23, wherein the controller processes MPE-FEC redundancy section(s) only if the value of the reception function is greater than a predetermined threshold value.

27. The receiver according to claim 19, wherein the controller reaches a decision per one or more consecutively received data bursts based on prediction of error(s) in said one or more data bursts.

28. The receiver according to claim 24, wherein the controller calculates the reception function F after averaging N measurements of the parameters.

29. The receiver according to claim 24, wherein the controller calculates the reception function (F) according to any of the following policies:
a-priori, in ‘of-line’, at the laboratory;
at or during regular operation of the receiver; or
at or during off-time, between data bursts or during other time-slices.

30. The receiver according to claim 19, wherein the controller performs the prediction:
at or during other time-slices services;
at or during Service Information that may be transmitted intermittently every few seconds; or
at or during the re-synchronization phase just before receiving the next data burst.

31. The receiver according to claim 19, wherein the controller calculates reception history Fi as:
Fᵢ=μ*ƒ{ . . . }+(1−μ)*Fᵢ₋₁
wherein 0<μ≦1, ‘Fᵢ’ designates a weighted value (the value of the reception function) relating to the reception quality of a currently received data burst, ‘ƒ{ . . . }’ designates a value relating to the reception quality of a currently received data burst, and ‘Fᵢ₋₁’ designates a weighted value (the value of data burst(s) immediately preceding the current measurement).

32. The receiver according to claim 19, wherein the receiver is a Digital Video Broadcasting (DVB) Handheld receiver, or it complies with the DVB-H standard or it is designed to process received error-correction data identical or similar to MPE-FEC sections.

33. In a DVB-H receiver comprising a controller, demodulator and MPE-FEC unit:
predicting by said controller reception error(s) associated with a data burst to be received by said receiver; and
deciding by said controller, based on the prediction result, to process or to eschew processing of MPE-FEC redundancy section(s) associated with said data burst, prior to receiving said data burst by said receiver.

34. The receiver according to claim 33, wherein predicting comprises evaluating by the controller future reception quality before receiving the data burst, by using data provided by the demodulator.

35. The receiver according to claim 34, wherein evaluating is based on calculating a reception function (F) at the receiver.

36. The receiver according to claim 35, wherein the controller evaluates the reception function by using measured or calculated, scaled or weighted, parameter(s) associated with data received prior to the reception of the data burst.

37. The receiver according to claim 36, wherein the data received prior to the reception of the data burst is associated, or derived from, previously received data burst(s) or data received between previously received data bursts.

38. The receiver according to claim 40, wherein the controller processes MPE-FEC redundancy section(s) only if the value of the reception function is greater than a predetermined threshold value.
